(19) United States
(12) Patent Application Publication
(10) Pub. No.: US 2007/0248903 A1
(43) Pub. Date: Oct. 25, 2007

(54) TONER

(75) Inventor: Yasuko Nakagawa, Neyagawa-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: KYOCERA MITA CORPORATION, Osaka (JP)

(21) Appl. No.: 11/736,839

(22) Filed: Apr. 18, 2007

(30) Foreign Application Priority Data
Apr. 20, 2006 (JP) 2006-116579

(51) Int. Cl. G03G 9/08

(52) U.S. Cl. 430/109.3; 430/111.4; 430/123.52

(57) ABSTRACT

A toner which excels in offset resistance at a high temperature and a low temperature and fixing performance and which can perform fixation at a low temperature is provided. Such a toner is one which includes toner mother particles, such that a temperature T° C. satisfies the following relationship:

η(T+5)/η(T)≧1

provided that a melting viscosity at a temperature T° C. is expressed as η(T) and a melting viscosity at a temperature (T+5)° C. is expressed as η(T+5).

### BACKGROUND OF THE INVENTION

1. Field of the Invention

The present invention relates to a toner. Priority is claimed on Japanese Patent Application No. 2006-116579, filed Apr. 20, 2006, the content of which is incorporated herein by reference.

2. Description of the Related Art

Conventionally, a method is known for forming an image using, for example, a copier, a facsimile, a laser beam printer, which consists of charging the surface of a photosensitive body made of a photo-conductive material with an electrostatic charge, exposing the surface to form an electrostatic latent image, adhering toner to this electrostatic latent image and developing it to obtain a toner image, transferring the resultant toner image to a transferring medium such as paper, and thereafter fixing the image by heating and pressing.

A toner contains toner mother particles which contain a binder resin and a colorant, and if necessary, other agents.

There is a problem in that a high temperature offset may occur in the method of fixing the toner image by heating and pressing. This is a phenomenon in which a cohesive force among toners which are fused by heating during fixation will be reduced and some of the toner image will be transferred to a fixing roller, such that the toner is adhered to the subsequent recording medium to stain the recording medium.

The melting viscosity of the toner is required to be higher in order to improve the high temperature offset resistance and thermal resistance of the toner. However, if the melting viscosity of the toner is high, then there is a problem in that it becomes difficult to obtain a low temperature fixing performance, that is, a performance capable of sufficiently fixing a toner image at a relatively low temperature, and the fixing temperature range will be narrow, although it excels in high temperature offset performance. Moreover, if the melting viscosity is high, there is a problem in that in the case of the fixing temperature being low, thermal energy will be insufficient, and only the toner at the side close to the fixing roller will melt, whereas the toner close to the recording medium will not melt, and as a result, the adhering force between the fixing roller and the toner will be greater than the adhering force between the toner and the recording medium, such that the toner image is adhered to the fixing roller and then the same toner will be adhered to the subsequent recording medium, i.e. a low temperature offset phenomenon will occur.

The following patent document 1 (Japanese Registered Patent Publication No. 2512442) has an object to reconcile the offset resistance with low temperature fixing performance of toner and has disclosed a resin having a gelling component as a binder resin for the toner, which is obtained by polymerizing a liquid mixture which contains a linear polymer, a polymerizable monomer, and a cross linking agent.

However, it has been difficult to reliably achieve both favorable high temperature offset resistance and low temperature fixing performance by a conventional teaching.

The present invention was made in view of the above circumstances, and it is an object of the present invention to provide a toner which excels in offset resistance at a high temperature and a low temperature and fixing performance and which can achieve fixation at a low temperature.

### SUMMARY OF THE INVENTION

In order to solve the above problems, the present invention provides a toner including toner mother particles, such that a temperature T° C. satisfies the following relationship:

η(T+5)/η(T)≧1

wherein a melting viscosity at a temperature T° C. is expressed as η(T) and a melting viscosity at a temperature (T+5)° C. is expressed as η(T+5).

### EFFECT OF THE INVENTION

The toner in accordance with the present invention excels in offset resistance at high temperature, offset resistance in low temperature, and fixing performance, and can achieve fixation at low temperature.

### BRIEF DESCRIPTION OF THE DRAWINGS

FIG. 1 is a graph which shows the results of examples and comparative examples.

### DETAILED DESCRIPTION OF THE INVENTION

### [Melting Viscosity]

The toner of the present invention is one including toner mother particles, such that a temperature T° C. satisfies the following relationship:

### η(T+5)/η(T)≧1, wherein a melting viscosity at a temperature T° C. is expressed as η(T) and a melting viscosity at a temperature (T+5)° C. is expressed as η(T+5).

In general, the melting viscosity of a toner is likely to be reduced monotonously, as the temperature is elevated, however, the toner of the present invention has a temperature performance such that the melting viscosity will remain at the same level or increase when the temperature is elevated from T° C. to T+5° C.

The melting viscosity of a toner in the present invention is a value measured by the following method.

That is, an apparent change of the melting viscosity with a change of temperature is measured under the following conditions, using a flow tester “CFT series” made by Shimazu Seisakusyo Co., Ltd. as a measuring apparatus, by which a product is obtained by pressing a toner under a pressure of 100 kg/cm² using the compressing press machine attached to the above flow tester.

Temperature elevating rate: 6° C./min,

### Starting temperature (preheating temperature): 40° C.,

Preheating time: 300 sec,

### Load: 20 kg,

Die diameter: 1 mm,
Die length: 1 mm,

### Plunger cross-section: 1.0 cm².

In the correlation between the temperature and the melting viscosity obtained by such a measurement, there is a temperature region where the melting viscosity increases or remains at the same level as the temperature is elevated, thereby it becomes possible to reduce the melting viscosity appropriately in a low temperature region, and it becomes possible to suppress an excessive decrease in the melting viscosity in a high temperature region.

The temperature (T° C.) where such a phenomenon occurs is preferably within a temperature region ranging from 110° C. to 130° C.

If the temperature T° C. is too low, then the reduction of melting viscosity in a low temperature region will be large, a toner will easily melt at a high temperature and a high temperature offset may occur. On the other hand, if the temperature T° C. is too high, then the melting viscosity in a high temperature region will increase, a toner will hardly melt at a low temperature and a low temperature offset may occur.

### [Toner Mother Particle]

The toner having a specific temperature performance in accordance with the present invention can be obtained by using toner mother particles which contain a large amount of a gelling component which swells in tetrahydrofuran (THF).

What is referred here as “toner mother particles which contain a gelling component which swells” means those having a characteristic such that pellet-like gels which have swelled are present in THF, when allowing the pellets to stand in 20 ml of THF for 24 hours, which are obtained by pressing and shaping 0.1 g of toner mother particles with a pressing force of 100 kg/cm² into a cylindrical pellet having a height of 1 mm and a diameter of 1 cm.

The volume average particle size of the toner mother particles is preferably not more than 8 μm. An image having excellent quality can be obtained by making the volume average particle size not less than 8 μm. The volume average particle size is measured by a pore electric resistance method.

In a preferred embodiment of the present invention, the toner mother particle is one which is formed by polymerizing a mixture which contains a polymerizable monomer, a molecular weight modifier and a cross-linker, and the mass ratio of the cross-linker is not less than 1.1 provided that the content of the molecular weight modifier in the mixture is determined to be 1, and the content of gelling component in the toner mother particles is not less than 30 mass %.

The content of gelling component in the present invention is a value which is measured by the following method. At first, toner mother particles are placed in a container and weighed. Subsequently, a large amount of THF is poured into the container, and the resultant mixture is allowed to stand for 24 hours. While allowing it to stand, the container is shaken several times, so as to promote diffusion of THF-soluble contents of the toner mother particles into THF. Thereafter, it is allowed to stand for 48 hours or more to precipitate gelling components. The supernatant liquid is removed with a dropping pipet, and then the gelling components are dried and weighed.

Provided that the mass (unit: g) of the toner mother particle used in the measurement is expressed as T, the mass (unit: g) of the dried product of the resultant gelling component is expressed as S, the percentage (unit: mass %) of the gelling component contained is calculated from the following numerical formula (1):

Percentage of gelling component contained=(S/T)×100 (1)

In the present invention, in the mixture used for polymerizing the toner mother particles, by making the mass ratio of the cross-linker to the content of the molecular weight modifier not less than 1.1, it becomes possible to obtain toner mother particles which contain the gelling component amount of not less than 30 mass % and which contains the gelling component which swells.

The upper limit of the mass ratio is not limited particularly, but the mass ratio is preferably not less than 2.3 from a viewpoint of acquiring the target gelling component quantity, more preferably not less than 1.8.

In the present invention, by making the content of the gelling component in the toner mother particles not less than 30 mass %, it becomes possible to attain favorable fixing performance in a broader temperature region.

In the present invention, the upper limit of the content of the gelling component in the toner mother particles is not limited particularly, but from the viewpoint of preventing the generation of blistering at a low temperature, the content of the gelling component is preferably not more than 50 mass %, more preferably not more than 45 mass %.

The content of the gelling components in the toner mother particles can be adjusted by, for example, the kind of cross-linker, consumed amount and cross-linking conditions.

### [Polymerizable Monomer]

As for the polymerizable monomer (it may be referred to as “a monomer for forming a binder resin”, below), those which are known well as a monomer which constitutes a binder resin of the toner mother particle can be used appropriately.

As the binder resin, specifically, styrene type resin, such as polystyrene, styrene type copolymer, etc.; acryl type resin such as polymethylmethacrylate, etc.; polyolefin type resin such as polyethylene, polypropylene, ethylene-α-olefin copolymer, etc.; vinyl chloride type resin such as polyvinyl chloride, polyvinylidene chloride, etc.; polyester type resin such as polyethylene terephthalate, polybutylene terephthalate, etc.; polyamide type resin; poly urethane type resin; polyvinyl alcohol type resin; thermoplastic resin such as vinyl ether type resin etc. are exemplary. Of these, styrene type resin is preferable, and styrene type copolymer is particularly preferable.

The above styrene type copolymer is the copolymer which mainly consists of styrene type monomer. As the styrene type monomer, for example, styrene, o-methyl styrene, p-methyl styrene, etc. are exemplary, and styrene is preferably exemplary. As another monomer which is copolymerized with the styrene type monomer, for example, p-chlorostyrene, vinylnaphthalene, alkanes (monoolefins) such as ethylene, propylene, butylene, isobutylene, etc.; halogenated vinyl such as vinyl chloride, vinyl bromide, vinyl fluoride, etc.; vinyl esters such as vinyl acetate, vinyl propionate, vinyl butyrate, vinyl benzoate, etc.; (meth)acrylates such as methyl acrylate, ethyl acrylate, n-butyl acrylate, isobutyl acrylate, dodecyl acrylate, n-octyl acrylate, 2-chloroethyl acrylate, phenyl acrylate, α-chloro methyl acrylate, methyl methacrylate, ethyl methacrylate, butyl methacrylate, 2-ethyl hexyl methacrylate, n-octyl methacrylate, etc.; nitrogen containing acrylic acid derivatives such as acrylonitrile, methacrylonitrile, acrylic amide, etc.; vinyl ethers such as vinyl methyl ether, vinyl isobutyl ether, etc.; vinyl ketones such as vinyl methyl ketone, vinyl ethyl ketone, methyl isopropenyl ketone, etc.; nitrogen-containing vinyl compounds such as N-vinyl pyrrol, N-vinyl carbazole, N-vinyl indole, N-vinyl pyrroliden are exemplary. Of the other monomers, one kind may be copolymerized with styrene type monomer alone, or two or more thereof may be copolymerized with a styrene type monomer in combination. Of the other monomers, (meth)acrylate is preferable, (meth)acrylate of an aliphatic alcohol having 1 to 12 carbon atoms (still more preferably having 3 to 8 carbon atoms) is more preferable, and 2-ethyl hexyl methacrylate is still more further preferable.

### [Cross-Linker and Molecular Weight Modifier]

As the cross-linker, for example, aromatic divinyl compounds such as divinylbenzene, divinyl naphthalene, etc.; carboxylic acid esters such as ethyleneglycol diacrylate, ethylene glycol dimethacrylate, 1,3-butanediol dimethacrylate, etc.; divinyl compounds such as divinyl aniline, divinyl ether, divinyl sulfide, divinyl sulfone, etc. are exemplary. Each of them may be used alone or in combination of two or more thereof.

### [Molecular Weight Modifier]

As the molecular weight modifier, for example, mercaptans such as a t-dodecyl mercaptan, n-dodecyl mercaptan, n-octyl mercaptan, 2,2,4,6,6,-pentamethylheptane-4-thiol, halogenated hydrocarbons such as carbon tetrachloride, carbon tetrabromide are exemplarly. Each of them may be used alone or in combination of two or more thereof.

The added amount of the cross-linker preferably ranges from 0.1 to 10 parts by mass to 100 parts by mass of the monomer for forming a binder resin, the added amount of the molecular weight modifier preferably ranges from 0.1 to 5 parts by mass to 100 parts by mass of the monomer for forming a binder resin, and the mass ratio of the added amount of the cross-linker is preferably not less than 1.1 provided that the added amount of the molecular weight modifier is determined to be 1.

### [Colorant]

To the mixture which is used for polymerizing the toner mother particles, a colorant is usually added. As a preferable colorant, an inorganic pigment, an organic pigment, a synthetic dye, etc. are exemplary. Each of these colorants may be used alone, or for example, one or more of inorganic pigments and/or an organic pigment may be used in combination of one or more of dyes.

As an inorganic pigment, for example, metallic powder type pigments (for example, iron powder, copper powder, etc.), metal oxide type pigments (for example, magnetite, ferrite, ferric oxide red, etc.), carbon type pigments (for example, carbon black, furnace black, etc.) and the like are exemplary.

As an organic pigment, for example, azo type pigments (for example, a benzidine yellow, a benzidine orange, etc.), acidic dye type pigments and basic dye type pigments (for example, precipitates obtained by precipitating a dye such as quinoline yellow, acid green, alkali blue, etc. with a precipitant, precipitates obtained by precipitating a dye such as rhodamine, magenta, malachite green, etc. with tannic acid, phosphomolybdic acid, etc.), mordant dye type pigments (for example, metallic salts of hydroxy anthraquinones, etc.), phthalocyanine type pigments (for example, phthalocyanine blue, sulfonated copper phthalocyanine, etc.), quinacridone type pigments and dioxane type pigments (such as quinacridone red, quinacridone violet, etc.) are exemplary.

As synthetic dyes, for example, aniline black, azo dye, naphthoquinone dye, indigo dye, nigrosin dye, phthalocyanine dye, polymethine dye, tri- and diaryl methane dye are exemplary.

The compounded amount of the colorant preferably ranges from 1 to 50 parts by mass, and more preferably ranges from 1 to 20 parts by mass to 100 parts by mass of the monomer for forming a binder resin.

### [Waxes]

To the mixture which is used for polymerizing the toner mother particles, waxes are preferably added in order to improve the fixing performance of toner, or to prevent the offset or image smearing higher efficiently. As the above waxes, for example, a polyethylene wax, a polypropylene wax, Teflon™ type wax, Fischer-Tropsch wax, paraffin wax, carnauba wax, ester wax, montan wax, rice wax, etc. are exemplary. Each of these waxes may be used alone, or in combination one or more thereof.

The added amount of the above waxes preferably ranges from 1 to 10 parts by mass to 100 parts by mass of the monomer for forming a binder resin. If the added amount of waxes is less than the above range, then the offset or the image smearing may not be prevented efficiently. On the other hand, if the added amount of waxes is more than the above range, then toner is likely to be fused to each other, thereby storing stability may deteriorate.

### [Charging Controlling Agent]

To the mixture which is used for polymerizing the toner mother particles, charging controlling agents are preferably added, if necessary. It is possible to improve the charging level of toner, the charging rising performance (i.e. an index which indicates the ability of being charged up to a specific electric charge level in a short time), or improve performance such as durability or stability of toner. Moreover, in the case in which a toner is positively charged, a positively charging controlling agent is compounded, whereas in the case in which a toner is negatively charged, a negatively charging controlling agent is compounded, and well known charging controlling agents can be suitably used.

The added amount of charging controlling agent preferably ranges from 1 to 15 parts by mass, more preferably ranges from 1.5 to 8 parts by mass, and still more preferably ranges from 2 to 7 parts by mass to 100 parts by mass of the monomer for forming a binder resin. If the added amount of charging controlling agent is too small, then it may become difficult to charge toners stably, and when an image is formed using such a toner, image concentration may deteriorate, or stability of image concentration may deteriorate. Moreover, if the added amount of charging controlling agent is too small, then poor dispersing of the charging controlling agent is likely to occur, which leads to a so-called fogging or photosensitive body pollution may significantly occur. On the other hand, if the added amount of the charging controlling agent is too much, then environmental resistance may deteriorate, particularly poor charging or poor image may occur remarkably, or photosensitive body pollution may easily occur.

### [Magnetic Powder]

In the case of using the toner as a magnetic component developer, magnetic powder may be added to a mixture for polymerizing toner mother particles. As the magnetic powder, for example, ferromagnetic metals, alloys thereof or compounds containing these elements, such as iron such as ferrite, magnetite, etc., cobalt, nickel, etc.; ferromagnetic element-free alloys which will be ferromagnetic by performing an appropriate heat treatment; chromium dioxide etc. are exemplary.

The amount of the magnetic powder preferably ranges from 50 to 100 parts by mass to 100 parts by mass of the monomer for forming a binder resin.

### [Polymerizing Method]

The toner mother particles are obtained by polymerizing a mixture which contains these components. As the polymerizing method, suspension polymerization method or emulsifying polymerization method is preferably used.

### [Suspension Polymerization Method]

In the case of preparing toner mother particles by suspension polymerization method, the monomer for forming a binder resin, the colorant, the wax, the charging controlling agent, the cross-linker, the molecular weight modifier are dispersed in an aqueous medium (for example, water or a mixed solvent consisting of water and a water-compatible solvent), and a suspension stabilizer is added to the aqueous medium, if necessary. Subsequently, the resultant aqueous medium is stirred, so as to convert the components which contain the monomer for forming a binder resin etc. into particles having appropriate particle size in the aqueous medium, and thereafter, a polymerization initiator is added thereto and heating, thereby obtaining toner mother particles.

The amount of the aqueous medium in the suspension polymerization preferably ranges from 300 to 1000 parts by mass to 100 parts by mass of the monomer for forming a binder resin.

As the polymerization initiator, for example, azo or diazo type polymerization initiators such as 2,2-azobis (2,4-dimethyl valeronitrile), 2,2′-azobis-(2,4-dimethyl valeronitrile), 2,2′-azobis isobutyronitriles, 1,1′-azobis (cyclohexane-1-carbonitrile), 2,2′-azobis-4-methoxy-2,4-dimethyl valeronitrile, azobis isobutyronitrile; peroxide type polymerization initiators such as benzoyl peroxide, methyl ethyl ketone peroxide, diisopropyl peroxy carbonate, cumene hydroperoxide, 2,4-dichlorobenzoyl peroxide, lauroyl peroxide, etc. are exemplary. The polymerization initiator may be used alone or in combination of two or more thereof. The added amount of the polymerization initiator preferably ranges from 0.5 to 20 parts by mass to 100 parts by mass of the monomer for forming a binder resin.

As the suspension stabilizer, for example, one which can be easily removed by an acid washing after polymerization (those which exhibit neutral or alkaline in water) is preferable. As such a suspension stabilizer, for example, inorganic compounds such as the third calcium phosphate, magnesium phosphate, aluminum phosphate, zinc phosphate, calcium carbonate, magnesium carbonate, etc.; organic compounds, such as polyvinyl alcohol, gelatin, methyl cellulose, methyl hydroxypropyl cellulose, ethyl celluloses, or sodium salt thereof are exemplary. The added amount of the suspension stabilizer preferably ranges from 0.2 to 10 parts by mass to 100 parts by mass of the monomer for forming a binder resin.

A surfactant in an amount ranging from 0.001 to 0.5 parts by mass may be added to 100 parts by mass of the monomer for forming a binder resin, in order to miniaturize the suspension stabilizer. As the surfactant referred to here, for example, sodium dodecyl benzene sulphonate, sodium oleate, sodium laurylate, potassium stearate, oleic acid calcium oleate, etc. are exemplary.

Size of the toner mother particles obtained by suspension polymerization can be adjusted by stirring rate and stirring time of the aqueous medium which contains the components. Although, stirring rate or stirring time during polymerization is not particularly limited, for example, at first the mixture is stirred at a rate ranging from 2000 to 10000 rotations/min for 5 minutes to 1 hour, and then maintaining the particle state and stirring it at a level which can prevent precipitation of particles, thereby polymerizing at a temperature ranging from 50 to 90° C. for 2 to 20 hours. Thus, a dispersing fluid of the toner mother particles can be obtained. The polymerization is preferably performed under a nitrogen atmosphere.

### [Emulsion Polymerization Method]

In the case of preparing the toner mother particles by an emulsion polymerization method, in general, resin dispersion fluid which is prepared by emulsion polymerization is mixed with an additive dispersion fluid which is prepared by dispersing colorant, wax, charging controlling agent, etc. in a solvent to form agglomerate particles corresponding to the particle size of the toner mother particles, and thereafter the resultant particles are heated to be fused to each others, thereby obtaining the toner mother particles.

In accordance with this method, the toner mother particles having a higher circularity can be prepared.

In the emulsion polymerization for preparing the above resin dispersion fluid, for example, similar to those illustrated in the above suspension polymerization, a monomer for forming a binder resin, a cross-linker, a molecular weight modifier, ion exchanged water, and water-soluble polymerization initiator are mixed at a predetermined percentage, and the resultant mixture is reacted, for example, under the condition of a temperature ranging from 10 to 90° C., stirring rate ranging from 10 to 1000 rotation/minute, for a time ranging from 1 to 24 hours.

As a water-soluble polymerization initiator, for example, persulfates such as potassium persulphate, ammonium persulphate, etc.; water-soluble azo type polymerization initiators such as 2,2′-azobis (2-amidino propane) dihydrochloride; water-soluble radical polymerization initiators such as hydrogen peroxide, etc.; redox type polymerization initiators in which the above persulphate etc. is combined with reducing agents such as sodium hydrogen sulfite, sodium thiosulfate, etc. are exemplary.

The emulsion polymerization is preferably performed under an inert gas (for example, nitrogen gas, etc.) atmosphere. In addition, the average particle size of the resin particles in the resin dispersion fluid preferably ranges from 0.01 to 1 μm.

On the other hand, the above additive dispersion fluid can be obtained by, for example, compounding the colorant, wax, charging controlling agent, etc. at a predetermined percentage in an aqueous medium, and adding dispersing agent if necessary, and dispersing and mixing the resultant mixture by a dispersing means such as a ball mill, etc.

As the aqueous media, for example, water such as distilled water, ion exchanged water, etc.; for example alcohols are exemplary. These can be used alone or in combination one or more thereof.

As the dispersing agent, for example, anionic surfactants such as alkyl sulfate type (for example, sodium dodecyl sulfate, etc.), sulfonate type (for example, sodium dodecyl benzene sulfonate, sodium alkyl naphthalene sulfonate, etc.), phosphate type, soap type, sodium dialkylsulfosuccinate, etc.; cationic surfactants such as amine salt type, quaternary ammonium salt type (for example, alkylbenzene dimethyl ammonium chloride, alkyl trimethyl ammonium chloride, distearyl ammonium chloride, etc.) etc.; non-ionic surfactants, such as, polyethylene glycol type, alkyl phenol ethylene oxide adduct type, polyol type, etc. are exemplary. Of these, anionic surfactants, and cationic surfactants are preferable. In addition, the non-ionic surfactant is preferably used together with an anionic surfactant or a cationic surfactant. The above surfactants may be used alone, or in combination one or more thereof.

For forming the above agglomerate particles, for example, salts such as sodium chloride are added as a coagulant. In the adding method of the coagulant, an aqueous solution of the above coagulant is dropped over a time ranging from 10 minutes to 24 hours with stirring, into a mixed dispersion fluid obtained by mixing the above resin dispersion fluid with the additive dispersion fluid. At this time, the temperature of the mixed dispersion fluid is preferably lower than the glass transition temperature (Tg) of the resin contained in the resin dispersion fluid.

After having brought up the agglomerate particles, the temperature is elevated to be not less than the glass transition temperature (Tg) of the resin contained in the resin dispersion fluid so as to fuse the agglomerate particles. The fusing of the agglomerate particles is performed for a time ranging from 10 minutes to 24 hours with stirring. Thus, the toner mother particles are formed.

### [Other Additive Agent]

To the toner mother particles, an additive (additive agent) is added if necessary and mixed, thereby obtaining toner mother particles. As the additive agent, for example, titan oxide fine particles, silica fine particles are exemplary.

Although the amount of the additive (additive agent) is not particularly limited, for example, the amount preferably ranges from 0.1 to 5 parts by mass to 100 parts by mass of the toner mother particles.

Although the method for adhering the additive agent to the toner mother particles is not particularly limited, for example, a method of mixing the toner mother particles with the additive agent using an apparatus such as Henschel mixer is exemplary.

In accordance with the present invention, the toner which excels in the offset resistance in a high temperature, the offset resistance in a low temperature, and the fixing performance, and can perform a fixation at a low temperature is provided.

In general, as the gelling component contained in the toner mother particles increases, the offset resistance will increase, whereas the lower limit of fixing temperature will be higher. On the other hand, if the gelling component is small, then effects such as offset resistance are likely to be insufficient.

To the contrary, in the toner of the present invention, there is a temperature region where the melting viscosity of the toner increases or remains on the same level as the temperature is elevated. And when the toner is fixed by pressing and heating, the resin other than the gelling component will start to melt in a low temperature region, and hence the melting viscosity is maintained at a relatively low level. Thus, even if the gelling component is large, fixing at a low temperature will be possible, and the toner excels in the offset resistance at a low temperature. On the other hand, in a high temperature region which is more than a certain temperature Tx, the gelling component will start to melt, and hence the melting viscosity will be higher, thereby preventing the generation of the offset at a high temperature.

In addition, it is possible to increase the amount of the gelling component in the toner mother particles, because of forming the toner mother particles by polymerization method. If the mother particles are formed by a crushing method, then the amount of the gelling component will be decreased because the gel size will be reduced by shearing force during the crushing process, even if the amount of the gelling component before crushing is increased. In the case of producing the toner mother particles by polymerization method, no crushing process is performed, and hence the gel size will be maintained at a relatively large state, and as a result, it is preferable to obtain the toner mother particles having a large amount of gelling component.

### EXAMPLES

The present invention will be explained in more detail below using examples, however, the present invention is not limited to these examples. Each measurement in examples, and evaluation were conducted as follows.

### (Measurement of Particle Size)

Particle size distribution of the toner mother particles was measured using Multisizer 3 (made by Beckman Instruments coulters Co., Ltd.) to obtain a volume average particle size.

### (Evaluation of Offset-Resistance)

As the evaluation apparatus, DP560 (product name, made by Mita Industrial Co., Ltd.) was used.

A solid image having a size of 30 mm×30 mm is output on the tip of paper, and it was observed whether an offset is generated or not by viewing.

If an offset was not generated at the roller surface temperature of 200° C., then the high temperature offset is expressed as 0, whereas if an offset was generated, then it is expressed as X.

If an offset was not generated at the roller surface temperature of 150° C., then the low temperature offset is expressed as 0, whereas if an offset was generated, then it is expressed as X.

### (Evaluation of Fixing Performance)

A tape peeling test was used for evaluating fixing performance.

In other words, similar to the evaluation method for evaluating offset-resistance, a solid image is output at the roller surface temperature of 180° C., and an arbitrary cellophane tape was adhered to the toner fixed surface, and then the state of peeling when the tape was peeled off perpendicularly was judged using a boundary sample. The evaluation result is expressed as follows:

⊚: no peeling; ◯: although it is peeled slightly, it affects nothing on the density of viewing, Δ: although it is peeled slightly, it affects nothing on the density of viewing; X: it is peeled.

It should be noted that, by taking non-fixed images out from the apparatus main body, and measuring the amount of toner on the solid image using an absorbing apparatus during outputting each solid image, the amount of toner was adjusted such that the amount of toner on the paper per unit area should be constantly 0.7 mg/cm².

### Examples 1 to 3, Comparative Examples 1 to 3

Added amount of the cross-linker and of the molecular weight modifier were changed as shown in Table 1, and the toner mother particles were formed.

That is, a mixture which consisted of 80 parts by mass of styrene, 20 parts by mass of 2-ethyl-hexyl-methacrylate, 5 parts by mass of carbon black, 3 parts by mass of low-molecular weight polypropylene, 5.0 parts by mass of charging controlling agent N-07 (product name, made by ORIENT CHEMICAL Co., Ltd.), and a specific amount of divinyl benzene as a cross-linker was sufficiently dispersed through a ball-mill, and thereafter, 2 parts by mass of 2,2-azobis(2,4-dimethyl valeronitrile) as a polymerization initiator, and a specific parts by mass of t-dodecyl mercaptan as a molecular weight modifier were added, and the resultant mixture was added to 400 parts by mass of ion exchanged water. And further 5 parts by mass of tribasic calcium phosphate as a suspension stabilizer and 0.1 parts by mass of sodium dodecyl benzene sulfonate as a surfactant were added, and the resultant mixture was stirred at a rotation of 5000 rpm for 45 minutes using TK Homomixer (product name, made by TOKUSYU KIKA KOUGYOU Co., Ltd.) Subsequently, the mixture was reacted for 10 hours in a nitrogen atmosphere at a temperature of 70° C., stirring at 100 rpm, and thereafter the resultant mixture was subjected to an acid washing so as to remove tribasic calcium phosphate to obtain a dispersion liquid of toner mother particles. The resultant dispersion liquid was filtered, washed, and then dried to obtain original toner powder (toner mother particles). The volume average particle size of the resultant toner mother particles was 7.5 μm.

100 parts by mass of the original powder (toner mother particles) thus obtained, 0.8 parts by mass of silica RA200HS (product name, made by JAPAN AEROSIL Co., Ltd.) as the additive were mixed by a Henschel mixer at a circumferential speed of 3500 mm/sec for 10 minutes to obtain a toner.

In each of examples and comparative examples, the content of gelling component in the toner mother particles was measured by the above-mentioned method. The result is shown in Table 1.

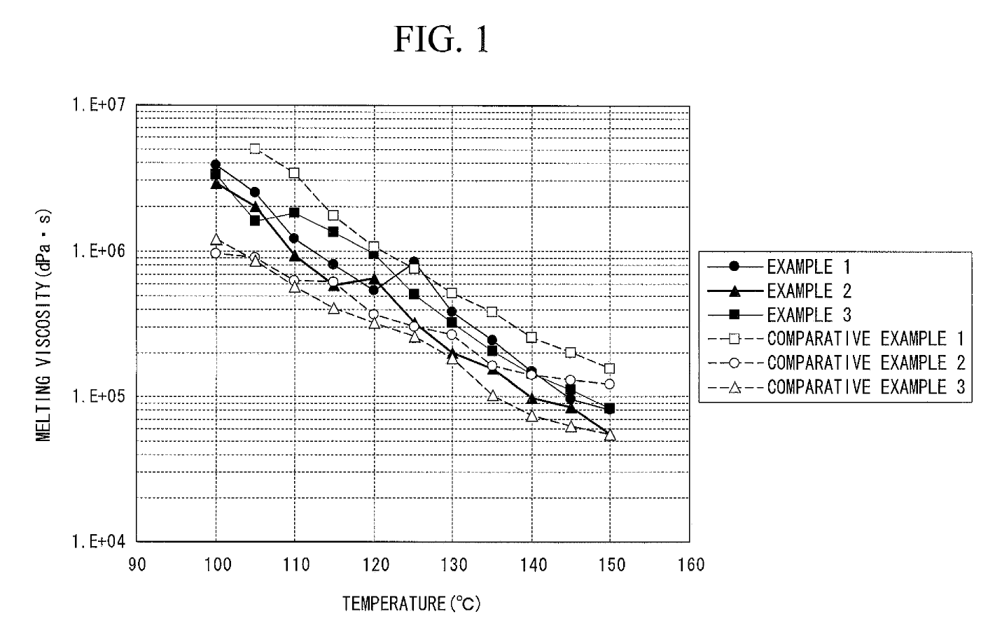

As to the toners obtained in each of examples and comparative examples, the melting viscosity was measured by the above-mentioned method. The result is shown in FIG. 1.

From the result shown in FIG. 1, the temperature T (° C.) at which melting viscosity increases when temperature is elevated from T ° C. to T+5° C. is shown in Table 1. Moreover, as to each toner, offset resistance and fixing performance were evaluated. The result is shown in Table 1.

TABLE 1

| | | | Molecular | Content of | Offset at a | Offset at a | |
|---|---|---|---|---|---|---|---|
| | T | | weight | gelling | high | low | Fixing |
| | (° C.) | Cross-linker | modifier | component | temperature | temperature | performance |
| Example 1 | 120 | 3.0 parts | 2 parts by | 45% | ◯ | ◯ | ⊚ |
| | | | mass | | | | |
| Example 2 | 115 | 2.0 parts | 2 parts by | 29% | ◯ | ◯ | ◯ |
| | | | mass | | | | |
| Example 3 | 105 | 2.5 parts | 2 parts by | 34% | ◯ | ◯ | ⊚ |
| | | | mass | | | | |
| Comparative | None | 1.8 parts | 2 parts by | 25% | X | ◯ | X |
| Example 1 | | | mass | | | | |
| Comparative | None | 1.5 parts | 2 parts by | 18% | X | X | Δ |
| Example 2 | | | mass | | | | |
| Comparative | None | 0.5 parts | 3 parts by | 3% | ◯ | X | Δ |
| Example 3 | | | mass | | | | |

From the result shown in FIG. 1 and Table 1, in Examples 1 to 3 in which the temperature T, at which melting viscosity increases when temperature is elevated from T° C. to T+5° C., is present, both offset resistance and fixing performance were favorable. In particular, in Examples 1 and 3, no offset was generated even at a high temperature and a low temperature, and the fixing performance was excellent.

On the other hand, in Comparative Examples 1 to 3, in which the temperature T was such the phenomenon was not exhibited, it was not possible to make favorable all of offset resistance at a high temperature, offset resistance at a low temperature, and fixing performance. In particular, in Comparative Example 1, the melting viscosity is relatively high, and hence although the offset at a high temperature was favorable, the offset at a low temperature and the fixing performance were poor.

Moreover, in Comparative Example 2, the melting viscosity was low and at a level such that gelling component was contained, and hence both the offset at a high temperature and the offset at a low temperature were poor.

Since in Comparative Example 3, the melting viscosity was relatively low, although both the fixing performance and the offset at a low temperature were favorable, the offset at a high temperature was poor.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A toner comprising toner mother particles, wherein a temperature T° C. satisfies the following relationship:
η(T+5)/η(T)≧1
provided that a melting viscosity at a temperature T° C. is expressed as η(T) and a melting viscosity at a temperature (T+5)° C. is expressed as η(T+5).

2. The toner as set forth in claim 1, wherein said temperature T is within a temperature region ranging from 110 to 130° C.

3. The toner as set forth in claim 1, wherein said toner mother particles are one formed by polymerizing a mixture which contains a polymerizable monomer, a molecular weight modifier and a cross-linker, and mass ratio of said cross-linker is not less than 1.1 provided that the content of said molecular weight modifier in said mixture is determined to be 1, and the content of gelling component in said toner mother particle is not less than 30 mass %.

4. The toner as set forth in claim 1, wherein said toner mother particles have a volume average particle diameter of not more than 8 μm.

5. The toner as set forth in claim 3, wherein said mass ratio of said cross-linker ranges from 1.1 to 2.3.

6. The toner as set forth in claim 3, wherein said mass ratio of said cross-linker ranges from 1.1 to 1.8.

7. The toner as set forth in claim 1, wherein said content of gelling component in said toner mother particles ranges from 30 mass % to 50 mass %.

8. The toner as set forth in claim 3, wherein said content of gelling component in said toner mother particles ranges from 30 mass % to 45 mass %.

9. The toner as set forth in claim 1, wherein said toner mother particles contain (meth) acrylic ester of an aliphatic alcohol having 1 to 12 carbon atoms as a binder resin.

10. The toner as set forth in claim 1, wherein said toner mother particles contain 2-ethyl hexyl methacrylate as a binder resin.

11. The toner as set forth in claim 1, wherein said cross-linker is contained in an amount ranging from 0.1 to 10 parts by mass to 100 parts by mass of said polymerizable monomer.

12. The toner as set forth in claim 1, wherein said molecular weight modifier is contained in an amount ranging from 0.11 to 5 parts by mass to 100 parts by mass of said polymerizable monomer.

13. The toner as set forth in claim 1, wherein said toner mother particles contain a colorant in an amount ranging from 1 to 50 parts by mass to 100 parts by mass of said polymerizable monomer.

14. The toner as set forth in claim 1, wherein said toner mother particles contain a colorant in an amount ranging from 1 to 20 parts by mass to 100 parts by mass of said polymerizable monomer.

15. The toner as set forth in claim 1, wherein said toner mother particles contain a wax in an amount ranging from 1 to 10 parts by mass to 100 parts by mass of said polymerizable monomer.

16. The toner as set forth in claim 1, wherein said toner mother particles contain a charging controlling agent in an amount ranging from 1 to 15 parts by mass to 100 parts by mass of said polymerizable monomer.

17. The toner as set forth in claim 1, wherein said toner mother particles contain a magnetic powder in an amount ranging from 50 to 100 parts by mass to 100 parts by mass of said polymerizable monomer.
